(19) United States
(12) Patent Application Publication
(10) Pub. No.: US 2011/0205037 A1
(43) Pub. Date: Aug. 25, 2011

(54) CIRCUIT BUZZER

(76) Inventor: Denis Barish, Monroe, GA (US)

(21) Appl. No.: 12/710,580

(22) Filed: Feb. 23, 2010

(51) Int. Cl. G08B 3/00

(52) U.S. Cl. 340/384.1

(57) ABSTRACT

The presently disclosed embodiments, as well as features and aspects thereof, are directed towards providing a device that can produce an audible, and adjustable, noise signal or annunciation in response to being energized by an electrical circuit. Generally, embodiments of a circuit buzzer are useful for remote determination of a circuit's state, i.e. whether the circuit is “live” or “dead.” Embodiments of a circuit buzzer, at a minimum, may comprise components operable to electromechanically produce an audible signal. Further, embodiments may comprise an adjustable housing aspect, such as a housing having a base configured to receive a threaded top piece, useful for varying the decibel level of any produced audible signal. Even so, it is anticipated that some embodiments may comprise additional features and aspects such as, but not limited to, circuit connection adaptor components, LEDs, transformer circuitry, speakers, computer readable mediums, processors, electronics, etc.

### BACKGROUND

If you are either a meticulous home owner or a professional electrician, perhaps the most beautiful thing you have ever seen is a clearly, and accurately, labeled electrical panel box. Most homes, however, and even some commercial or industrial sites, contain panel boxes that are grossly mislabeled, unlabeled or altogether convoluted.

Electrical panels allowed to exist in such undesirable states can cause serious headaches for electricians, at a minimum. In some cases, poorly maintained electrical panels can even represent a danger or liability. Regardless of the condition of a particular panel, a person seeking to modify the electrical system in which the panel is a central component must work with what is there. Inevitably, before any electrical work can be done, a series of troubleshooting questions must be answered at the panel box. For example, is the outlet really faulty or has the breaker been tripped? Which breaker is the right one? How many outlets or potential loads are presently landed on a certain 20 amp circuit? Does the circuit on a given breaker really span multiple rooms? Before one puts a screwdriver to an electrical outlet, questions such as these should always be asked while standing in front of the panel.

Because it is such commonplace for a panel to be incorrectly labeled, if labeled at all, electricians have many tools and methods for arriving at answers to those upfront questions. Suppose, for example, that an electrician is seeking to determine if a wall outlet is “live,” i.e. whether the outlet is operable to deliver power. A simple first step may be to “plug” a light into the outlet in order to see if the light turns on. If so, then logically, the outlet is live. A similar technique may be to plug a radio or some other electrical device into the outlet. Moreover, the electrician could use a volt-ohm meter, amp meter or some other detection device placed in contact with the outlet in order to see if a positive reading is generated. Notably, each of these techniques works just fine to determine that an outlet is live but, before a prudent electrician will begin work on an electrical circuit, it must be positively determined that the outlet, and thus the circuit, is “dead.”

To remove power from an electrical circuit, thereby making it safe to modify or repair, the breaker at the panel that is dedicated to the circuit must be tripped or turned off. Of course, if the panel is clearly labeled, then the electrician will know precisely which breaker to trip before returning to the circuit and beginning work. But, as we've established, panels are all too often not clearly labeled. So, how does an electrician determine which breaker is the correct one when the electrical panel is in disarray? Well, if the aforementioned outlet residing on the circuit is within clear sight of the panel, then the electrician only needs to leave the light or radio plugged into the outlet while systematically tripping one breaker at a time until the light or radio is turned off. Besides the inconvenience of carrying around a lamp or radio, such a technique is simple enough. The problem with such a technique, however, is that more often than not the electrical panel is not within sight of the lamp, thus making it impossible for the electrician standing at the electrical panel to see whether the tripped breaker caused the lamp to turn off.

As to using a radio as a means for determining whether a tripped breaker has removed power from a circuit, an electrician tripping breakers at a panel can simply listen until the radio is silenced, thereby determining that power has been removed from the given outlet. Even so, a radio is not an ideal device for determining whether a breaker has removed power from a remote circuit. For example, a radio is limited in that it can only be plugged directly into a power outlet. As such, if the outlet that the electrician wants to be representative of the target circuit is inconvenient to reach (perhaps, located behind furniture), then the radio is no longer such a convenient tool. Also, the audible noise emanating from a radio can be difficult to discern from other common noise sources and, therefore, it may not be readily apparent to the electrician, who may be a number of rooms and/or floors away from the radio, that the radio has gone silent. Even further, a radio is cumbersome, to say the least, and is not a convenient tool for an electrician to include in his “bag of tricks.”

For all the reasons set forth above, as well as other reasons, prior art in the field of circuit testing devices are inadequate. Therefore, there is a need in the art for a conveniently portable device that may be inserted into an electrical outlet and, if the outlet is live, produce a distinctive annunciation, the decibel level of which may be adjusted according to preference. Further, there is a need in the art for an embodiment of such a device that may be inserted into a light bulb socket that is, in turn, connected to a circuit.

### BRIEF SUMMARY

A circuit buzzer, generally, is a device operable to generate an audible annunciation or signal when connected to an electrical current. More particularly, embodiments of a circuit buzzer comprise electromechanical components operable to create mechanical noise or signals such as, but not limited to, buzzing, clicking, banging, whirring, vibrating, etc. Importantly, it will be understood that the use of the term “buzzer” in the title and throughout the present specification is not intended to limit the scope of the disclosure to a circuit testing device that produces a “buzz” type annunciation or signal. Rather, while some embodiments of a circuit buzzer do, in fact, produce a buzz from an electromechanical source component, it is anticipated that other embodiments of a circuit buzzer will be operable to produce other types of signals including, but not limited to, beeps, whistles, tones, prerecorded sounds, etc. Further, some embodiments of a circuit buzzer may also comprise components that can store and play digital sound files. Still other embodiments of a circuit buzzer may incorporate non-audible signal features such as, but not limited to, light emitting diodes (LEDs), digital readouts, graphical displays, etc. Therefore, it will be clear that the use of the term “buzzer” is intended to encompass all forms of annunciation or signal generation that may be comprised within any given embodiment of the invention.

An exemplary embodiment of a circuit buzzer comprises an electromagnetic coil and armature combination mounted inside a variable space housing. The coil is wired to a pair of prongs, such as an outlet plug arrangement as is generally known in the art, such that the coil is energized when the prongs are in communication with an AC voltage source (a residential wall outlet, for example). As is known in the art, the electromagnetic coil, in conjunction with a ferrous component, operates to magnetize the ferrous component in a cycle that correlates with the phase of the AC voltage. As such, an armature component positioned relative to the electromagnet can be made to pivot towards the magnetic field created by the electromagnet and forcibly brought into contact with a mechanical stop, i.e. bumper wall or strike surface, thereby producing an audible noise. A spring or some other means can be included to provide a mechanical force that pivots the armature away from the bumper wall when the AC voltage phase causes the electromagnet to change poles, thus positioning the armature for the next strike. In this way, a “buzz” can be generated, the decibel level of which may be varied according to the set distance of the armature relative to the bumper walls.

Again, the particular methodology used to create the audible output may vary according to any number of techniques known in the art and, as such, the use of an AC voltage driven electromagnetic coil is offered herein for exemplary purposes only. Moreover, while features and aspects of some components used in some embodiments of a circuit buzzer in order to create an audible output may be novel in and of themselves, the inclusion or exclusion of any given annunciation component or group of components will not limit the scope of a circuit buzzer. For example, it is anticipated that some embodiments of a circuit buzzer may comprise piezos, solenoids or other electromechanical components known in the art.

As has been described relative to the use of an AC voltage driven electromagnetic coil and armature combination, the decibel level of the audible output generated from the cycled contact of the armature with a bumper wall may be varied according to the maximum gap distance allowed between the armature and bumper wall. It is well known in the art that electromagnetic buzzers may include set screw features for varying the armature gap. A circuit buzzer, however, may include a variable housing component as a dual and/or redundant decibel adjustment. More specifically, the variable housing component of some embodiments of a circuit buzzer may provide a mechanism by which the internal space of the housing, in which the buzzer components reside, may be varied. Advantageously, embodiments with an adjustable housing component provide a means by which a user can vary the decibel level of the audible output simply by twisting or otherwise adjusting the variable housing, thus alleviating the need to adjust a set screw in order to vary the armature gap. By varying the internal spacing within the housing, the maximum stroke of the armature may be affected without requiring that the armature gap be adjusted relative to the bumper wall. Generally speaking, adjusting the external housing such that the internal spacing is increased will cause the decibel output to be increased whereas adjusting the external housing such that the internal spacing is decreased will cause the decibel output to be decreased.

### BRIEF DESCRIPTION OF THE SEVERAL VIEWS OF THE DRAWING

FIG. 1 is a perspective view of an exemplary circuit buzzer shown inserted into a typical electrical outlet.

FIG. 2 is a cutaway view of an exemplary circuit buzzer comprising an electromagnetic signal generator.

FIG. 3 is an exploded view of the exemplary circuit buzzer depicted in FIG. 2.

FIG. 4 is a perspective view of the exemplary circuit buzzer depicted in FIG. 2, wherein the adjustable housing components have been separated.

FIG. 5 is a perspective view of an exemplary circuit buzzer shown in position to be inserted into a typical light bulb socket.

FIG. 6 is a side view of the exemplary embodiment illustrated in FIG. 5.

FIG. 7 is a perspective view of the exemplary embodiment depicted in FIGS. 5 and 6, further including an electrical outlet adapter component.

FIG. 8 is a side view of the exemplary embodiment illustrated in FIG. 7.

### DETAILED DESCRIPTION

The presently disclosed embodiments, as well as features and aspects thereof, are directed towards providing a device that can produce an audible, and in some embodiments, adjustable, noise signal or annunciation in response to being energized by an electrical circuit. Generally, embodiments of a circuit buzzer are useful for remote determination of a circuit's state, i.e. whether the circuit is “live” or “dead.”

Embodiments of a circuit buzzer, at a minimum, may comprise components operable to electromechanically produce an audible signal. Further, embodiments may comprise an adjustable housing aspect, such as a housing having a base configured to receive a threaded top piece, useful for varying the decibel level of any produced audible signal. Even so, it is anticipated that some embodiments may comprise additional features and aspects such as, but not limited to, circuit connection adaptor components, LEDs, transformer circuitry, speakers, computer readable mediums, processors, electronics, etc.

For example, some embodiments of a circuit buzzer include circuitry operable to transform an AC voltage source into a DC voltage source, thereby providing a source for energizing an LED, graphical display or some other signal means that can, in addition to a produced audible signal, provide a user with a visual verification of a voltage reading or provide power to a digital or analog circuit. Moreover, circuitry may be included in some embodiments of a circuit buzzer that can provide a user with other useful measurements such as, but not limited to, amperage, resistance, impedance, capacitance, continuity, etc.

Further, some embodiments of a circuit buzzer may comprise a generated audible sound, such as an analog or digital sound generator. For instance, the circuit buzzer may include a processor in communication with computer readable mediums, speakers, processors and other necessary circuitry such that when the embodiment is energized the signal emitted from the embodiment could be generated from a stored digital audio file or analog media device. Even further, some embodiments may combine multiple signal output means in order to provide a user with redundant verification of circuit state. For example, an embodiment of a circuit buzzer may combine an electromagnetic buzzer component with an AC/DC transformer circuitry operable to power an LED such that an AC power source may cause both the buzzer to actuate and the LED to energize.

Turning now to the figures, where like labels represent like elements throughout the drawings, various aspects, features and embodiments of a circuit buzzer will be presented in more detail. The examples as set forth in the drawings and detailed description are provided by way of explanation and are not meant as limitations on the scope of a circuit buzzer. A circuit buzzer thus includes any modifications and variations of the following examples as come within the scope of the appended claims and their equivalents.

FIG. 1 is a perspective view of an exemplary circuit buzzer 100 shown inserted into a typical three prong electrical outlet. Notably, one skilled in the art will understand that not all electrical outlets are of a three prong type and, as such, depicting the exemplary circuit buzzer 100 as being inserted into a three prong outlet will not limit the scope of a circuit buzzer or the applications in which a given circuit buzzer embodiment may be employed. For instance, other embodiments may be adapted for two-prong outlets, as well as other outlet configurations including 220 volt type outlets and foreign outlets. As can be seen in FIG. 1, the circuit buzzer 100 is emitting an audible annunciation or signal 110 as a result of being energized by the live electrical outlet. It should be understood that in the illustration the electrical outlet is “live,” thus energizing the circuit buzzer 100 such that an audible signal 110 is emitted. In the event that the electrical outlet was not live, the audible signal 110 would not be emitted.

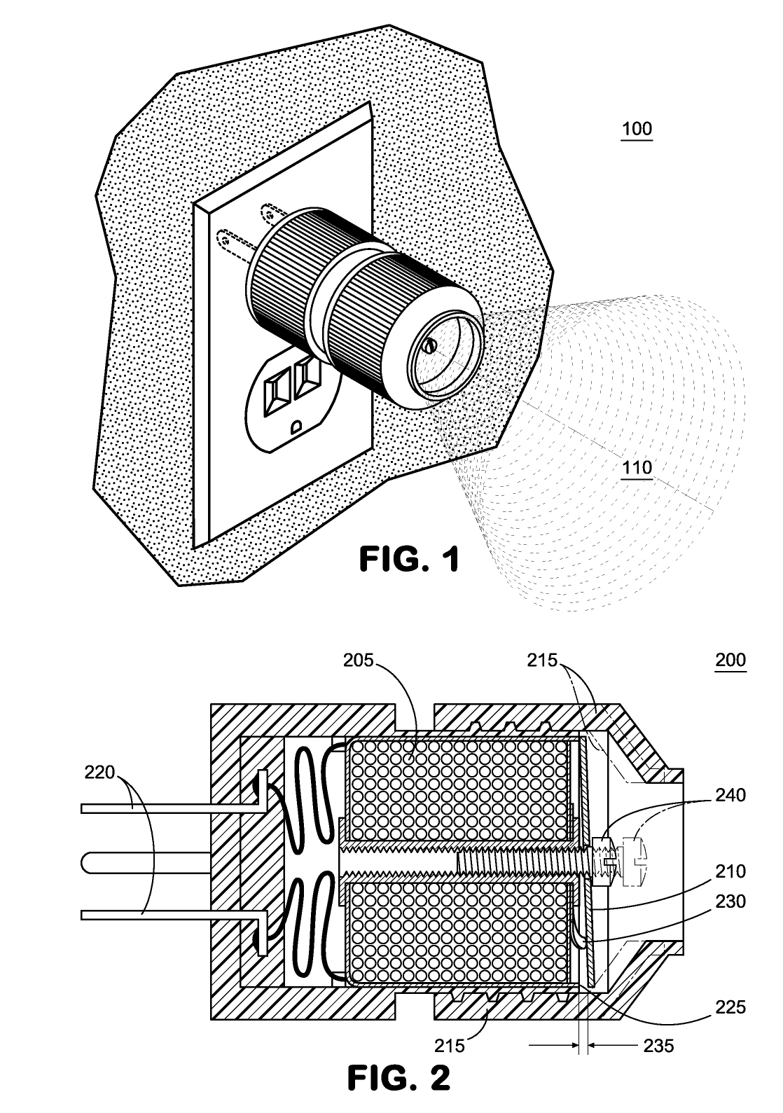

FIG. 2 is a cutaway view of an exemplary circuit buzzer 200 comprising an electromagnetic signal generator. The exemplary embodiment 200 comprises an electromagnetic coil 205 and armature 210 combination mounted inside a variable space housing 215. The coil 205 is wired to a pair of prongs 220 such that the coil 205 is energized when the prongs 220 are in communication with an AC voltage source (not shown). As is known in the art, the electromagnetic coil 205 is operable to generate a magnetic field that correlates with the cycling phase of the AC voltage source. As such, an armature component 210 positioned relative to the electromagnet can be made to pivot towards the magnetic field created by the electromagnet and forcibly brought into contact with a mechanical stop 225, i.e. bumper wall 225 or other strike surface, thereby producing an audible noise 110. A spring 230 or some other means can be included to provide a mechanical force that separates the armature 210 from the bumper wall 225 when the AC voltage phase causes the electromagnet to change poles. In this way, a “buzz” can be generated, the decibel level of which may be varied according to the set gap distance 235 of the armature 210 relative to the bumper wall 225.

The set gap distance 235 can be varied in the exemplary embodiment 200 by the inward or outward adjustment of a threaded set screw 240 component. By adjusting the set screw 240 inward, the gap distance 235 affected by the upward force of the spring 230 can be reduced. As such, the reduced gap 235 operates to lower the decibel level of an emitted signal 110 because the force of the armature 210 being pulled into the bumper wall 225 by the electromagnetic field is correspondingly reduced.

An additional feature of the embodiment 200 depicted in FIG. 2 is the variable space housing 215. The variable space housing is comprised of two components that are in communication via threads. As such, by adjusting the threaded communication of the variable space housing 215 components, the defined space in which the armature 210 may vibrate, regardless of the gap setting 235 determined by the set screw 240 position, can operate to dampen an emitted signal 110. Advantageously, by effectively adjusting the decibel level of an emitted signal 110 via adjustment of the housing, a user of the circuit buzzer 200 embodiment depicted in FIG. 2 does not have to adjust the set screw 240. The set gap distance 235 may determine a maximum, unimpeded decibel level for the emitted signal 110 but the variable space housing 215 may dampen the signal 110 according to application need.

Again, the particular audible signal generating component, i.e. the electromagnet and armature combination, is offered herein for illustrative purposes only. It is anticipated that other means for generating an audible signal may be comprised within other embodiments of a circuit buzzer. Regardless of the signal generation means, the adjustable housing aspect of many embodiments may be useful for quick and efficient dampening of signal decibel level.

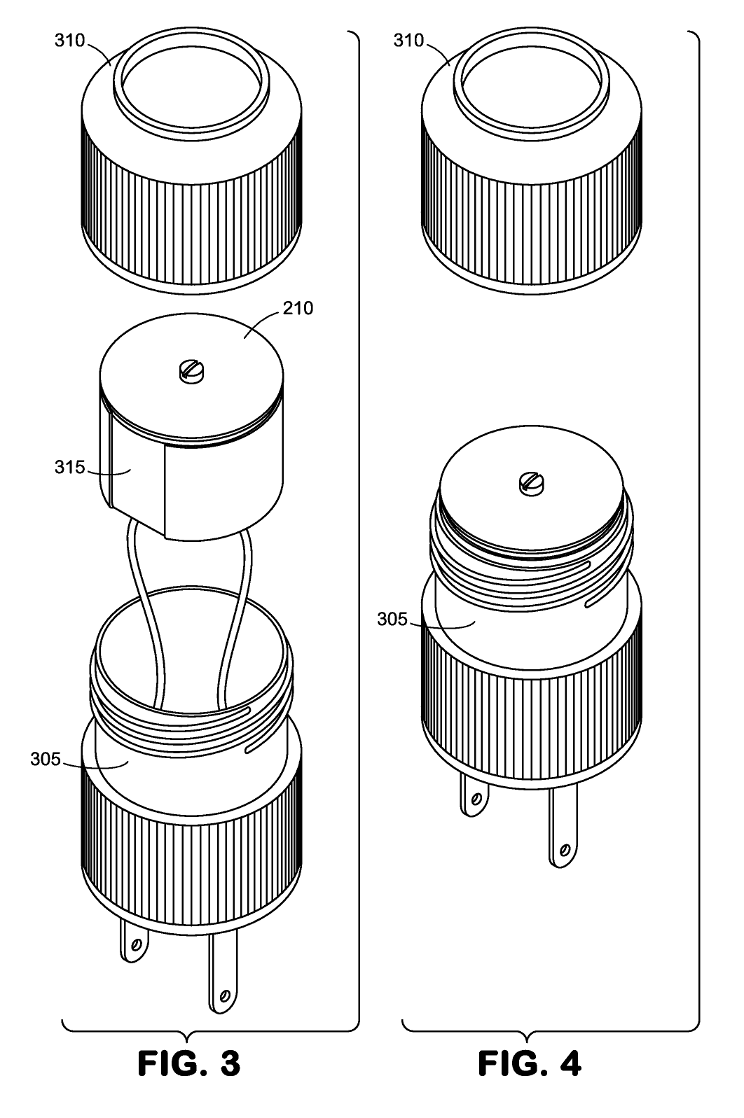

FIG. 3 is an exploded view of the exemplary circuit buzzer depicted in FIG. 2. In FIG. 3, it can be seen that the embodiment 200 can be disassembled. The variable space housing 215, consisting of a base component 305 and a top component 310 can be separated. The signal generating component 315 which, in the exemplary embodiment, is of an electromagnet/armature type can be removed from the variable space housing for repair or replacement. Importantly, not all embodiments of a circuit buzzer will necessarily feature components operable to be separated from one another or disassembled and, as such, disassembly or ease of repair is not a required feature in all embodiments of a circuit buzzer. It is anticipated that for cost effective manufacture, weatherproofing, or other expedient reasons, some embodiments of a circuit buzzer will not be operable for disassembly.

FIG. 4 is a perspective view of the exemplary circuit buzzer depicted in FIG. 2, wherein the adjustable housing components 215 have been separated. In FIG. 4, the signal generating components 315 are depicted in communication with the variable space housing 215 base component 305. The variable space housing 215 top component 310 is depicted in a separated state.

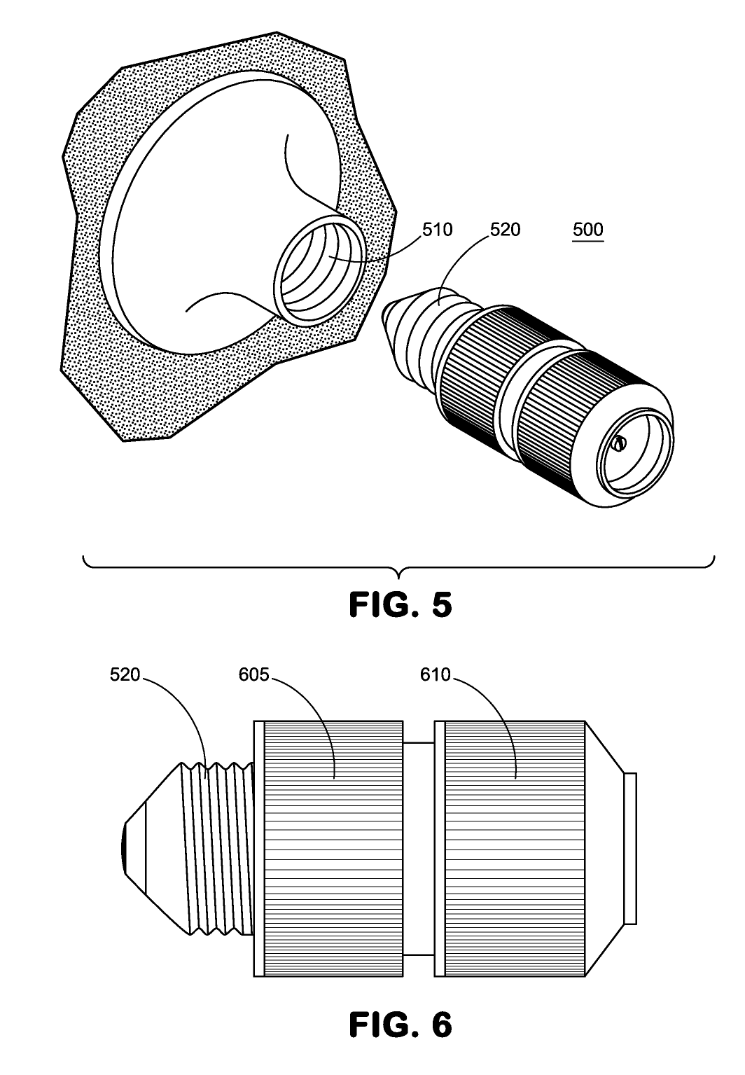

FIG. 5 is a perspective view of an exemplary circuit buzzer 500 shown in position to be inserted into a typical light bulb socket 510. Similar to the embodiment illustrated in FIG. 1, the exemplary embodiment 500 depicted in FIG. 5 is operable to emit an audible annunciation or signal 110 as a result of being energized. Unlike the FIG. 1 embodiment, however, the embodiment 500 in FIG. 5 features a screw base 520 operable to communicate with a typical light bulb socket 510. Advantageously, if a user desired to test a circuit at an outlet that was not configured for pronged devices, such as an outdoor sconce fixture, for instance, an embodiment 500 such as that depicted in FIG. 5 would be useful. Further, as not all pronged outlets are easily reached, an embodiment 500 may be inserted into the light bulb receptacle of a lamp that is already plugged into the pronged outlet.

FIG. 6 is a side view of the exemplary embodiment illustrated in FIG. 5. The light bulb base 520 can be seen as well as the top component 610 and base component 605 of the variable housing aspect.

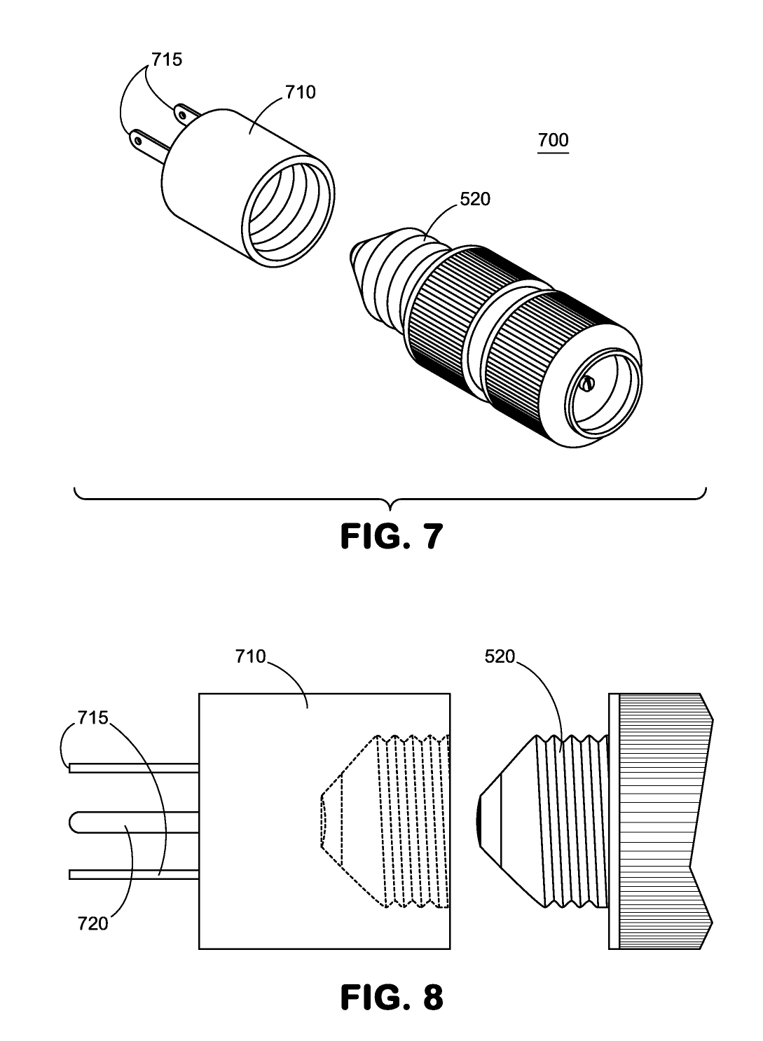

FIG. 7 is a perspective view of the exemplary embodiment depicted in FIGS. 5 and 6, further including an electrical outlet adapter component. Advantageously, some embodiments of a circuit buzzer 700 may further comprise adaptor components useful for converting the circuit buzzer from a prong configuration to a bulb base configuration, or vice versa. In the exemplary embodiment 700 depicted in FIG. 7, a circuit buzzer configured with a light bulb screw base 520 further comprises an adaptor component 710 that is operable to receive the threaded bulb base 520 of the buzzer component. The adaptor component 710, having prongs 715 operable to be inserted into a pronged electrical outlet, when in communication with the buzzer component, operates to make the circuit buzzer 700 suitable for insertion into a pronged outlet. Advantageously, a user of an embodiment that includes an adaptor component may not need to possess multiple embodiments in order to accommodate all applications.

FIG. 8 is a side view of the exemplary embodiment illustrated in FIG. 7. Again, the male bulb base 520 of the buzzer component may be screwed into the female receptacle of the adaptor component 710 such that the unit may be conveniently configured to insert into a pronged outlet. Also seen in FIG. 8, in addition to the prongs 715 required for connection to an electrical circuit via a pronged outlet, is a ground prong 720 as is known in the art. Importantly, not all embodiments of a pronged circuit buzzer or circuit buzzer adaptor component require a ground prong 720. Also, although the particular embodiment of a circuit buzzer depicted in FIGS. 7 and 8 illustrates a circuit buzzer operable to be adapted from a screw base to a pronged base, one skilled in the art will understand that a circuit buzzer with any given base configuration may be converted to an alternate base configuration via a suitable adaptor component. For instance, it is anticipated that a pronged circuit buzzer may be coupled with an adaptor component configured to receive the prongs and convert the circuit connection means to a screw base. Also it is anticipated that a circuit buzzer embodiment may feature nonstandard circuit connection aspects such as, but not limited to, spade connectors that can be received by any number of adaptor components, each of which features a different circuit connection means. Such an exemplary embodiment may advantageously provide a user with a single buzzer component and a variety of adaptors suitable for a variety of applications.

The present circuit buzzer has been described using detailed descriptions of embodiments thereof that are provided by way of example and are not intended to limit the scope of the device. The described embodiments comprise different features, not all of which are required in all embodiments of a circuit buzzer. Some embodiments of a circuit buzzer utilize only some of the features or possible combinations of the features. Variations of embodiments of a circuit buzzer that are described and embodiments of a circuit buzzer comprising different combinations of features noted in the described embodiments will occur to persons of the art.

It will be appreciated by persons skilled in the art that a circuit buzzer is not limited by what has been particularly shown and described herein above. Rather, the scope of a circuit buzzer is defined by the claims that follow.

What is claimed is:

1. An electrical circuit testing device, the device comprising:
an adjustable housing component, wherein adjusting the housing operates to vary the interior space defined within the housing;
a circuit connection component, wherein the circuit connection component is in rigid communication with the housing component and extends to the interior space of the housing component;
an audible signal generating component, wherein the audible signal generating component resides within the interior space defined by the housing component and is communicated to the circuit connection component;
wherein the audible signal generating component emits an audible signal when the circuit connection component is communicated with an energized electrical circuit; and
wherein the decibel level of the emitted audible signal may be modified by adjusting the housing component.

2. The device of claim 1, wherein the adjustable housing component is comprised of threaded lower and upper housings and the interior space defined by the adjustable housing component may be varied by varying the threaded position of the upper housing relative to the lower housing.

3. The device of claim 1, wherein the circuit connection component is pronged.

4. The device of claim 3, further comprising an adaptor component, wherein the adaptor component is operable to receive the pronged circuit connection component and exteriorly provide a threaded circuit connection.

5. The device of claim 1, wherein the circuit connection component is threaded.

6. The device of claim 5, further comprising an adaptor component, wherein the adaptor component is operable to receive the threaded circuit connection component and exteriorly provide a pronged circuit connection.

7. The device of claim 1, the audible signal generating component comprising an electromagnet and an armature, wherein an audible signal is generated when the electromagnet produces an electromagnetic field that causes the armature to strike a surface.

8. The device of claim 7, wherein the audible signal generating component further comprises an adjustment means for setting a maximum gap between the armature and strike surface.
